(19) United States
(12) Patent Application Publication
(10) Pub. No.: US 2021/0139216 A1
(43) Pub. Date: May 13, 2021

(54) DISPENSING DEVICE

(71) Applicant: Spencer D. Sutherland, Carlsbad, CA (US)

(72) Inventor: Spencer D. Sutherland, Carlsbad, CA (US)

(21) Appl. No.: 16/641,182

(22) PCT Filed: Aug. 24, 2018
(86) PCT No.: PCT/US2018/048007

§ 371 Date: Feb. 21, 2020

Related U.S. Application Data
(60) Provisional application No. 62/549,854, filed on Aug. 24, 2017.

(51) Int. Cl. B65D 75/58; B65D 75/32; B65D 83/00; A47K 5/122; A61J 1/06

(52) U.S. Cl. CPC B65D 75/5811; B65D 75/322; A61J 1/067; A47K 5/122; B65D 83/0055

(57) ABSTRACT

Dispensing devices are described which can contain at least one substance(s) that can be squished, emptied, extruded, and/or poured out. The dispensing devices can comprise a deformable housing including a top portion and a bottom portion forming an internal volume, a circumferential edge portion, and a dispensing port.

### CROSS REFERENCE TO RELATED APPLICATIONS

This application claims the benefit of U.S. provisional patent application No. 62/549,854, filed Aug. 24, 2017, the entire disclosure of which is incorporated herein by reference.

### SUMMARY

Described herein generally are dispensing devices which can contain at least one substance that can be removed from the devices by deforming at least a portion of the device. In some embodiments, a substance can be squished, extruded, expelled, emptied and/or poured out. The dispensing devices can comprise a deformable housing, a circumferential edge portion, and a dispensing port. The dispensing devices can include internal volumes which can house the at least one substance either together or independently.

The deformable housing can include an internal volume. The deformable housing can include a top portion and a bottom portion.

The internal volume can be a void. Alternatively, the internal volume can be an encasement/housing which contains at least one substance. The at least one substance can include a condiment, a personal care product, a medicament, a health product, a beauty product, a sports nutrition product, an industrial product, or an alcoholic beverage. In some embodiments, the at least one substance is shampoo.

The circumferential edge portion can be a ring, securing mechanism, border, or rim and can protrude from the device or can be formed as a part of the device without protruding. The circumferential edge portion can separate the dispensing device's deformable housing into a top portion and a bottom portion.

The top portion and bottom portion of the deformable housing can include an indent, an inset groove, or the like. In some embodiments, there is no indent. The indent on the top portion and/or bottom portion of the deformable housing can be centered or off centered.

The indent can be configured for finger placement. The finger placement can be accomplished by placing an index finger on the top portion of the deformable housing and a thumb on the bottom portion of the deformable housing. In some embodiments, the finger placement can be accomplished by placing two fingers on the top portion of the deformable housing and a thumb on the bottom portion of the deformable housing. In other embodiments, an index finger and a middle finger are placed on the top portion of the deformable housing and a thumb on the bottom portion of the deformable housing.

The dispensing port can be elevated on the top portion of the deformable housing and can be substantially flat along the circumferential edge portion.

In some embodiments, the circumferential edge portion can be substantially uniform around all of dispensing device. In other embodiments, the circumferential edge portion can be substantially uniform around most of dispensing device, but then protrude out into an appendage. The appendage can be large enough to have a thumb resting surface.

The dispensing port can be a flat back break tip.

Methods are also described where at least one substance is dispensed from the dispensing device by squeezing at least a portion of the deformable housing. In some embodiments, one half portion of the device can collapse into the other half portion of the device. In other embodiments, the bottom portion of the device collapses into the top portion of the device.

In some embodiments, a method for dispensing comprises extruding at least one substance from the dispensing device by applying pressure from a first finger and a second finger on the top portion and a thumb on the bottom portion; wherein the dispensing device includes a deformable housing including the top portion and the bottom portion forming an internal volume including the at least one substance; a circumferential edge portion; and a dispensing port wherein the dispensing port is elevated on the top portion of the deformable housing and the dispensing port is substantially flat along the circumferential edge portion. In some embodiments, the first finger can be the index finger, the middle finger, the ring finger, or the pinky finger. In other embodiments, the second finger can be the index finger, the middle finger, the ring finger, or the pinky finger. In some embodiments, the first finger is the index finger and the second finger is the middle finger. In other embodiments, the first finger, the second finger, and the thumb belong to a user, wherein the user can be a mammal. In some embodiments, the mammal is a human.

The dispensing device can be formed partially or completely from compressible material wherein the compressible material contains at least one polymer.

The dispensing device can have any shape that can be at least partially deformed to remove the substance from the internal volume. In one embodiment, the dispensing device can be substantially spherical. The dispensing device can also comprise a substantially circular or oval cross-section.

The internal volume can be about 10 mL, about 20 mL, about 30 mL, about 40 mL, about 50 mL, about 60 mL, about 70 mL, about 80 mL, about 90 mL, or about 100 mL.

In other embodiments, the internal volume can be about 3.0 fluid ounces, about 6.0 fluid ounces, about 0.5 to about 1.0 fluid ounces, about 1.0 to about 2.0 fluid ounces, about 2.0 to about 3.0 fluid ounces, about 3.0 to about 4.0 fluid ounces, about 4.0 to about 5.0 fluid ounces, or about 5.0 to about 6.0 fluid ounces.

### BRIEF DESCRIPTION OF THE DRAWINGS

FIG. 1 illustrates a perspective view of the dispensing device.

FIG. 2 illustrates a top view of the dispensing device.

FIG. 3 illustrates a bottom view of the dispensing device.

FIG. 4 illustrates a first side view of the dispensing device.

FIG. 5 illustrates a second side view of the dispensing device.

FIG. 6 illustrates a back view of the dispensing device.

FIG. 7 illustrates a front view of the dispensing device.

### DETAILED DESCRIPTION

Described herein are dispensing devices configured to contain at least one substance. The dispensing devices can be formed in such a manner that the substance(s) can be emptied from the devices by applying pressure to and/or deforming at least a portion of the device. Upon applying pressure and/or deforming at least a portion of a device, the substance(s) can be squished, extruded, dispensed, or emptied out. In some embodiments, the substances can be poured out. In other embodiments, the dispensing device can comprise a deformable housing including an internal volume, a circumferential edge portion, and a dispensing port. The at least one substance can be contained within the internal volume.

In other embodiments, a dispensing device can be a deformable housing including a top portion and a bottom portion forming an internal volume; a circumferential edge portion; and a dispensing port wherein the dispensing port is elevated on the top portion of the deformable housing and the dispensing port is substantially flat along the circumferential edge portion.

In some embodiments, a dispensing device can be formed from two halves or portions, a top portion and a bottom portion, along the circumferential edge portion. The top and bottom portion can have an indent for finger placement. The top portion can include a dispensing port. Further, the top portion can be formed of rigid and/or non-deformable material and the bottom portion can be formed of a compressible and/or deformable material. In other embodiments, both the top and bottom portions of the dispensing device are formed of a compressible and/or a deformable material.

In some embodiments, one halve of the device can collapse into the other halve of the device. In other embodiments, the bottom portion of the device collapses into the top portion of the device. In some embodiments, the top portion of the device collapses into the bottom portion of the device. The collapsibility of the top/bottom portion of the dispensing device into the top/bottom portion of the dispensing device allows for the expulsion of the entire or substantially entire contents of the dispensing device. Substantially can be about 75%, about 80%, about 85%, about 90%, about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 100%, between about 75% to about 85%, between about 85% to about 95%, between about 99.1% to about 99.9%, between about 90% to about 100%, or between about 95% to about 100%.

In some embodiments, the top portion and the bottom portion are both made of compressible/deformable material. In other embodiments, the top and bottom portion are both made of rigid material. In some embodiments, the top portion is made of rigid material and the bottom portion is made of compressible/deformable material. In yet other embodiments, the top portion is made of compressible/deformable material and the bottom portion is made of rigid material.

In other embodiments, as illustrated in FIG. 1, dispensing device 100 comprises deformable housing 102, circumferential edge portion 104, indent 106, and dispensing port 108. Deformable housing 102 of dispensing device 100 can also include a top portion 112 and a bottom portion 116 (as shown in FIGS. 4-7). Dispensing device 100 can also include dotted tear line 110. Dotted tear line 110 can indicate where to tear dispensing device 100 in order to open dispensing port 108 and expel the contents of deformable housing 102.

In some embodiments, the tear can occur along the sloped portion of dispensing port 108. In other embodiments, the tear can occur right before the sloping portion of dispensing port 108. In other embodiments, the tear can occur after the sloping portion of dispensing port 108. In some embodiments, dotted tear line 110 can be located before the sloping portion of dispensing port 108. In other embodiments, dotted tear line 110 can be located after the sloping portion of dispensing port 108. In some embodiments, dotted tear line 110 can be located at the sloping portion of dispensing port 108.

In some embodiments, circumferential edge portion 104 can be substantially uniform around all of dispensing device 100. In other embodiments, circumferential edge portion 104 can be substantially uniform around most of dispensing device 100, but then protrude out into appendage 114. In some embodiments, circumferential edge portion 104 and appendage 114 can be separated by dotted tear line 110. In some embodiments, dotted tear line 110 can be in the center of appendage 114. In other embodiments, dotted tear line 110 can be about one-third onto appendage 114 or about three-fourths onto appendage 114.

In some embodiments, the deformable housing and circumferential edge is stronger than the appendage which is weaker. In other embodiments, the deformable housing and circumferential edge is stronger than the appendage which is weaker/weakened because the dispensing port is stretched or has been compressed. This allows for the easy break off of the appendage by either tearing along the dotted line or by applying pressure to one side of the appendage. This composition allows for an easy break/snap of the appendage when pressure is applied. It also allows for a clean cut tear. It also permits the ability to easily empty the contents of the deformable housing in about two seconds or less. The ability to perform a clean cut tear can be important to the consumer because if the tear is not clear cut then it may prevent the consumer from fully expelling at least one substance from the deformable housing. The devices described herein allow for this clean cut and therefore the ability to easily expel at least one substance from the deformable housing in under about two seconds.

In some embodiments, circumferential edge portion 104 and appendage 114 are bonded. In other embodiments, circumferential edge portion 104 and appendage 114 are not bonded. In some embodiments, the bonding is completed by thermal bonding or the like.

In some embodiments, appendage 114 can be large enough to have a thumb resting surface. In other embodiments, appendage 114 can be smaller than a thumb resting surface. In yet other embodiments, appendage 114 can be larger than a thumb resting surface.

In some embodiments, dispensing port 108 can protrude from deformable housing 102 onto circumferential edge 104 and appendage 114 as illustrated in FIG. 1. In other embodiments, dispensing port 108 can protrude onto circumferential edge 104 and not onto appendage 114. In yet other embodiments, dispensing port 108 can protrude onto circumferential edge 104 and halfway, one-third, or three-fourths onto appendage 114.

In some embodiments, dispensing port 108 can come to a close onto appendage 114 at a perpendicular angle to appendage 114. In other embodiments, dispensing port 108 can come to a close at an angle, slope, or arc onto appendage 114. As FIG. 5 illustrates dispensing port 108 can come to a close at angle α. Angle α can be about 5°, about 10°, about 15°, about 20°, about 25°, about 30°, about 35°, about 40°, about 45°, about 50°, about 55°, about 60°, about 65°, about 70°, about 75°, about 80°, about 85°, about 90°, less than about 5°, less than about 10°, less than about 15°, less than about 20°, less than about 25°, less than about 30°, less than about 35°, less than about 40°, less than about 45°, less than about 50°, less than about 55°, less than about 60°, less than about 65°, less than about 70°, less than about 75°, less than about 80°, less than about 85°, less than about 90°, less than about 95°, more than about 5°, more than about 10°, more than about 15°, more than about 20°, more than about 25°, more than about 30°, more than about 35°, more than about 40°, more than about 45°, more than about 50°, more than about 55°, more than about 60°, more than about 65°, more than about 70°, more than about 75°, more than about 80°, more than about 85°, more than about 90°, between about 5° to about 10°, between about 15° to about 20°, between about 10° to about 20°, between about 15° to about 25°, between about 20° to about 30°, between about 25° to about 35°, between about 30° to about 40°, between about 35° to about 45°, between about 40° to about 50°, between about 45° to about 55°, between about 50° to about 60°, between about 55° to about 65°, between about 60° to about 70°, between about 65° to about 75°, between about 70° to about 80°, between about 75° to about 85°, or between about 80° to about 90°.

In some embodiments, dispensing device 100 can be held by placing a thumb on indent 106 of top portion 112 and the index finger of the same hand on indent 106 of bottom portion 116. Alternatively, dispensing device 100 can be held by placing a thumb on indent 106 of bottom portion 116 and the index finger of the same hand on indent 106 of top portion 112.

In other embodiments, dispensing device 100 can be held by placing a thumb on bottom portion 116 and at least one finger of the same hand on top portion 112. In some embodiments, dispensing device 100 can be held by placing a thumb on bottom portion 116 and the index finger and middle finger of the same hand on top portion 112.

In other embodiments, a user can tear off appendage 114 at dotted line 110, place an index finger and thumb of the same hand on indents 106, and apply pressure to indents 106 thereby emptying the contents of deformable housing 102. The packaging can be convenient in that it can allow a person to open and use dispensing device 100 with one hand. In some embodiments, while holding dispensing device 100 in one hand, the user can apply pressure to appendage 114 using her thumb on the hand holding dispensing device 100, thereby breaking appendage 114. The user can then place the index finger and thumb of the same hand on indents 106, and apply pressure to indents 106 thereby emptying the contents of deformable housing 102. In other embodiments, the user can place an index finger, a middle finger, and a thumb of the same hand on indents 106, and apply pressure to indents 106 thereby emptying the contents of deformable housing 102. In some embodiments, pressing down on the deformable housing can allow the bottom portion of the deformable housing to collapse into the top portion of the deformable housing thereby substantially expelling the at least one substance or the contents of the dispensing device. It is especially easy to use for those with physical ailments such as but not limited to arthritis. The use of one hand to open and use dispensing device 100 can be particularly convenient for people trying to multi-task. In some embodiments, the contents of dispensing device 100 can be completely expelled in under two seconds.

In some embodiments, the user can apply pressure to indents 106 using any fingers thereby emptying the contents of deformable housing 102. In some embodiments, the user can use any figures to stabilize the dispensing device. In other embodiments, the user can apply pressure to indents 106 using any part of the hand thereby emptying the contents of deformable housing 102. In some embodiments, the user can apply pressure to indent 106 using her palm thereby emptying the contents of deformable housing 102. In yet other embodiments, the user can apply pressure using alternative methods thereby emptying the contents of deformable housing 102. Alternative methods can include, but are not limited to, using a machine or tool to empty the contents of deformable housing 102.

Dispensing device 100 can have any shape that can hold at least one substance within internal volume. For example, dispensing device 100 can be substantially spherical. Dispensing device 100 can also comprise a substantially circular cross-section. A substantially spherical shape can allow the deformable housing to be print on and to be easily readable and seen from all angles. The print can include branding information, size, and the like. The deformable housing can include one or more linear portions. For example, it can include 1, 2, 3, 4, 5, 6, 7, 8, 9, 10, 11, 12, 13, 14, 15, 16, 17, 18, 19, 20, 21, 22, 23, 24, or 25 linear portions. The deformable housing can be any polygonal shape such as but not limited to a triangle, a square, a rectangle, a pentagon, a hexagon, a heptagon, an octagon, a nonagon, or a decagon. The enclosure can also be non-polygonal for example, a circle or oval.

Circumferential edge portion 104 can be a ring, securing mechanism, border, or rim. Circumferential edge portion 104 can include one or more linear portions. For example, it can include 1, 2, 3, 4, 5, 6, 7, 8, 9, 10, 11, 12, 13, 14, 15, 16, 17, 18, 19, 20, 21, 22, 23, 24, or 25 linear portions. Circumferential edge portion 104 can be a polygonal shape such as but not limited to a triangle, a square, a rectangle, a pentagon, a hexagon, a heptagon, an octagon, a nonagon, or a decagon. Circumferential edge portion 104 can also be non-polygonal for example, a circle or oval.

Appendage 114 can be substantially spherical. Appendage 114 can be a polygonal shape such as but not limited to a triangle, a square, a rectangle, a pentagon, a hexagon, a heptagon, an octagon, a nonagon, or a decagon. Appendage 114 can also be non-polygonal for example, a circle or oval.

Dispensing device 100 can be formed in a shape to allow multiple devices to be stacked in a storage compartment. In another embodiment, dispensing devices can be stored in a hopper where the removal of one dispensing device allows through gravity for the other dispensing devices to funnel down. Storage compartments can include a loader device or a hopper. A hopper can hold one or more devices that can feed into the top of a storage compartment. A hopper can house 1-10, 10-20, 20-30, 30-40, 40-50, 50-60, 60-70, 70-80, 80-90, 90-100, 100-500, 500-1,000, or 1,000-5,000 or more devices.

The ease of packaging and stackability of dispensing device 100 allows for clear advertising space. Even while stacked substantially all of top enclosure portion 112 and bottom enclosure portion 116 can be used for advertising space by the product housed by dispensing device 100 and/or can be clearly seen through a storage compartment allowing great marketability of the product. This can be very beneficial in attracting consumers of all types. Further, the stackability and ease of removing one dispensing device from a storage compartment without touching any of the other dispensing devices allows for a state of sterility among the dispensing devices remaining in a storage compartment. This application can be extremely useful in hospitals or doctor offices where sterility can be important. However, this application can also be beneficial among other establishments as well as people in today's age are very cautious about what they touch and what contaminants they come in contact with. For instance, people do not want someone else's germs on their dispensing device. Thus the ease in stackability and ability to remove one dispensing device without touching the other is very attractive to many individuals who are worried about becoming sick of fearful of encountering contaminants.

Dispensing port 108 can be any device, substance, or shape that can allow for sealing of the at least one substance within the internal volume of a device. Dispensing port 108 can include, but is not limited to break tips, caps, lids, snap caps, peel caps, pressure actuated slits, spray actuated nozzles, mist nozzles, adhesive tape, or adhesive alloy. In some embodiments, dispensing port 108 is a flat back break tip as illustrated in FIGS. 1-7. In embodiments where dispensing port 108 is a flat back break tip, dispensing port 108 can be elevated on top portion 112 of dispending device 100, and dispensing port 108 can be substantially flat along circumferential edge portion 104 of dispensing device 100. Alternatively, in other embodiments, dispensing port 108 can be elevated on bottom portion 116 of dispending device 100, and dispensing port 108 can be substantially flat on bottom portion 116 of dispensing device 100.

Dispensing device 100 can be made of a polymer, metal, textile or a combination thereof. Further, top portion 112 and bottom portion 116 of deformable housing 102 can be formed of the same or different materials. Polymeric materials can include but are not limited to thermosets, thermoplastics, solidified gels, tar, stucco, resin, rubber, vulcanized rubber, synthetic rubber, cement, silicone polymers, polyolefins, polyisobutylene, acrylic polymers, ethylene-co-vinylacetate, polybutylmethacrylate, vinyl halide polymers (for example, polyvinyl chloride), polyvinyl ethers (for example, polyvinyl methyl ether), polyvinylidene halides, polyacrylonitrile, polyvinyl ketones, polyvinyl aromatics, polyvinyl esters, acrylonitrile-styrene copolymers, ABS resins, ethylene-vinyl acetate copolymers, polyamides (for example, Nylon 66 and polycaprolactam), alkyd resins, polycarbonates, polyoxymethylenes, polyimides, polyethers, epoxy resins, polyurethanes, rayon, cellulose, cellulose acetate, cellulose butyrate, cellulose acetate butyrate, cellophane, cellulose nitrate, cellulose propionate, cellulose ethers, carboxymethyl cellulose, polytetrafluororethylene (for example, Teflon), combinations thereof, and the like. Metal or metallic materials can include but are not limited to aluminum, copper, tin, steel, iron, titanium, gold, silver, cobalt, chromium, or alloys or combinations thereof. Textile materials can include but are not limited to paper, cardboard, fiberboard, cotton, hemp, other polymeric textiles, and combinations thereof.

In other embodiments, dispensing device 100 can be formed of a combination or combinations of polymeric materials, metallic materials, and textile materials.

In yet another embodiment, the compressible material can be aseptic. The material can be aseptic in order to prevent the contents in dispensing device 100 from spoiling. This allows for the contents to be refrigerated only upon opening of dispensing device 100. For example, where the contents is sweetened condensed milk, the sweetened condensed milk would remain unspoiled due to compressible material which is aseptic thereby allowing the sweetened condensed milk to be fresh upon opening of dispensing device 100 and only require refrigeration after opening.

Further, dispensing device 100 can also have compressible material which is free of Bisphenol A (BPA). Compressible material free of BPA is safer for the environment and humans. BPA is an industrial chemical which has been found in plastic bottles and metal-based cans since the 1960's. Toxicity reports have shown that BPA can have negative effects on the brain, behavior, and prostate gland in fetuses, infants, and young children. As such dispensing device 100 can provide a safer way to package edible contents in comparison with other packaging materials that are not BPA free.

The internal volume can be but is not limited to a void, an encasement, an empty space, or enclosure.

In another embodiment the internal void is an encasement containing at least one substance. The at least one substance can be in the form of a fluid or viscous substance. For example it could be a liquid, solid, powder, cream, gel, polymer, or semi-solid.

In one embodiment the substance can be a condiment, such as but not limited to ketchup, mustard, mayonnaise (regular, light, low-fat, fat-free), relish, sweet relish, oil, vinegar, salad dressing, peanut butter, jelly, jam, sweetened condensed milk, grey poupon, BBQ sauce, honey mustard sauce, spicy wing sauce, A1 steak sauce, cocktail sauce, tarter sauce, jellied cranberry sauce, brown and white gravy, pizza tomato sauce, hot sauce, Tabasco sauce, sriracha hot chili sauce, soy sauce, teriyaki sauce, balsamic vinegar, honey, nutella, frosting, cooking oil, liquid pancake batter, liquid waffle batter, soft butter, sour cream, cream cheese and coffee creamer. Dispensing device 100 offers an innovative enhancement to the way current condiment packaging controls the consumer; dispensing device 100 gives the piloting controls back so the consumer can “land” the liquid anywhere they want, using just one hand.

In yet another embodiment the substance can be related to personal care such as but not limited to body lotion, hand lotion, aftershave, soap, hand sanitizer, bath salts, powder, gel, body oil, cream, shampoo, conditioner, sample shampoos, hair gels, body soaps/washes, moisturizer, shaving cream, toothpaste, facial soap, anti-aging cream, mouth wash, aspracream, sunscreen, soothing gels or creams, suntan lotion, sample intensive conditioners, and sexual lubricant. These substances can be packaged into dispensing device 100 at a certain travel size approved by the Transportation Security Administration (TSA). Further, the substances can be packaged into dispensing device 100 for single-use in hotels, cruise lines, resorts, hotel chains, fast food restaurants, and airport lounge retail stores.

In even yet another embodiment the substance can be a medicament, therapeutic agent, and/or drug which may or may not include an active agent. A medicament can include any compound or drug having a therapeutic effect in an animal. Exemplary, non limiting examples include anti-proliferatives including, but not limited to, macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, and the like. Exemplary FKBP-12 binding agents include sirolimus (rapamycin), tacrolimus, everolimus, temsirolimus and zotarolimus.

In one embodiment, a medicament can be baby Acetaminophen (TYLENOL®), single-use androgel, single-use NEOSPORIN®, single-use burn cream soother, single-use aloe vera, single-use arthritis cream, single-use cough syrup, hydrogen peroxide, sanitizer, or wound irrigation (ER surgery).

In another embodiment the substance can be related to health and beauty products such as, but not limited to, perfume, cologne, make-up, foundation, after-shave, and nail polish remover.

In yet another embodiment the substance can be related to sports nutrition such as, but not limited to, GU energy gel, hammer gel, liquid Gatorade concentrate, Gatorade fuel pouch, accel gel, protein powder, energy boosts, and stimulants.

In a further embodiment the substance can be related to industrial use such as machine oils or machine lubricants.

In yet another embodiment the substance can be alcoholic beverages (which are mixable or not), JELL-O® shots, paint, mosquito/bug spray repellant or cake frosting for cake decorating.

In another embodiment, dispensing devices as described herein can have an internal volume of 3.0 fluid ounces and in another 6.0 fluid ounces. The internal volume can be anywhere from 0.5 fluid ounces to about 1.5 liters. The internal volume can be about 0.5 to about 1.0 fluid ounces, about 1.0 to about 2.0 fluid ounces, about 2.0 to about 3.0 fluid ounces, about 3.0 to about 4.0 fluid ounces, about 4.0 to about 5.0 fluid ounces, about 5.0 to about 6.0 fluid ounces, about 6.0 fluid ounces to about 7.0 fluid ounces, about 7.0 fluid ounces to about 8.0 fluid ounces, about 8.0 fluid ounces to about 9.0 fluid ounces, about 9.0 fluid ounces to about 10.0 fluid ounces, about 10.0 fluid ounces to about 11.0 fluid ounces, about 11.0 fluid ounces to about 12.0 fluid ounces, about 12.0 fluid ounces to about 13.0 fluid ounces, about 13.0 fluid ounces to about 14.0 fluid ounces, about 14.0 fluid ounces to about 15.0 fluid ounces, about 15.0 fluid ounces to about 16.0 fluid ounces, about 16.0 fluid ounces to about 17.0 fluid ounces, about 17.0 fluid ounces to about 18.0 fluid ounces, about 18.0 fluid ounces to about 19.0 fluid ounces, about 19.0 fluid ounces to about 20.0 fluid ounces, about 21.0 fluid ounces to about 22.0 fluid ounces, about 22.0 fluid ounces to about 23.0 fluid ounces, about 23.0 fluid ounces to about 24.0 fluid ounces, about 24.0 fluid ounces to about 25.0 fluid ounces, about 25.0 fluid ounces to about 26.0 fluid ounces, about 26.0 fluid ounces to about 27.0 fluid ounces, about 27.0 fluid ounces to about 28.0 fluid ounces, about 28.0 fluid ounces to about 29.0 fluid ounces, about 29.0 fluid ounces to about 30.0 fluid ounces, about 30.0 fluid ounces to about 31.0 fluid ounces, about 31.0 fluid ounces to about 32.0 fluid ounces, about 32.0 fluid ounces to about 33.0 fluid ounces, about 33.0 fluid ounces to about 34.0 fluid ounces, about 34.0 fluid ounces to about 35.0 fluid ounces, about 35.0 fluid ounces to about 36.0 fluid ounces, about 36.0 fluid ounces to about 37.0 fluid ounces, about 37.0 fluid ounces to about 38.0 fluid ounces, about 38.0 fluid ounces to about 39.0 fluid ounces, about 39.0 fluid ounces to about 40.0 fluid ounces, about 40.0 fluid ounces to about 41.0 fluid ounces, about 41.0 fluid ounces to about 42.0 fluid ounces, about 42.0 fluid ounces to about 43.0 fluid ounces, about 43.0 fluid ounces to about 44.0 fluid ounces, about 44.0 fluid ounces to about 45.0 fluid ounces, about 45.0 fluid ounces to about 46.0 fluid ounces, about 46.0 fluid ounces to about 47.0 fluid ounces, about 47.0 fluid ounces to about 48.0 fluid ounces, about 48.0 fluid ounces to about 49.0 fluid ounces, about 49.0 fluid ounces to about 50.0 fluid ounces, about 50.0 fluid ounces to about 51.0 fluid ounces.

In another embodiment, dispensing devices as described herein can have an internal volume of 20 mL. The internal volume can be anywhere from about 20 mL fluid to about 100 mL. The internal volume can be about 1 mL, about 5 mL, about 10 mL, about 15 mL, about 20 mL, about 25 mL, about 30 mL, about 35 mL, about 40 mL, about 45 mL, about 50 mL, about 55 mL, about 60 mL, about 65 mL, about 70 mL, about 75 mL, about 80 mL, about 85 mL, about 90 mL, about 95 mL, about 100 mL, 1 ML, 5 mL, 10 mL, 15 mL, 20 mL, 25 mL, 30 mL, 35 mL, 40 mL, 45 mL, 50 mL, 55 mL, 60 mL, 65 mL, 70 mL, 75 mL, 80 mL, 85 mL, 90 mL, 95 mL, 100 mL, greater than 1 mL, greater than 5 mL, greater than 10 mL, greater than 15 mL, greater than 20 mL, greater than 25 mL, greater than 30 mL, greater than 35 mL, greater than 40 mL, greater than 45 mL, greater than 50 mL, greater than 55 mL, greater than 60 mL, greater than 65 mL, greater than 70 mL, greater than 75 mL, greater than 80 mL, greater than 85 mL, greater than 90 mL, greater than 95 mL, greater than 100 mL, less than 1 mL, less than 5 mL, less than 10 mL, less than 15 mL, less than 20 mL, less than 25 mL, less than 30 mL, less than 35 mL, less than 40 mL, less than 45 mL, less than 50 mL, less than 55 mL, less than 60 mL, less than 65 mL, less than 70 mL, less than 75 mL, less than 80 mL, less than 85 mL, less than 90 mL, less than 95 mL, less than 100 mL, between about 0.5 mL to about 5 mL, between about 5 mL and about 10 mL, between about 5 mL, about 15 mL, about 10 mL to about 20 mL, between about 15 mL to about 25 mL, between about 20 mL to about 30 mL, between about 25 mL about 35 mL, between about 30 mL to about 40 mL, between about 35 mL to about 45 mL, between about 40 mL to about 50 mL, between about 45 mL to about 55 mL, between about 50 mL about 60 mL, between about 55 mL to about 65 mL, between about 60 mL to about 70 mL, between about 65 mL to about 75 mL, between about 70 mL to about 80 mL, between about 75 mL to about 85 mL, between about 80 mL to about 90 mL, between about 85 mL to about 95 mL, between about 90 mL to about 100 mL, or about 95 mL to about 105 mL.

### EXAMPLE 1

### Shampoo

The dispensing device is used to apply shampoo while staying at a hotel. The person first takes the dispensing device and tears across the dotted tear line to open the dispensing port. The dispensing port is a flat back break tip. The person then holds the dispensing device by placing her index and middle finger on the indent of the top/bottom portion of the deformable housing and the thumb of the same hand on the indent of the opposite portion of the deformable housing. Any fingers can be used to stabilize the dispensing device. The thumb, index finger, and middle finger then apply pressure onto the indents of the top and bottom portions of the deformable housing thereby expelling the shampoo from the deformable housing onto the person's hair or hand. The person can then shampoo her hair. Further, the dotted tear line does not need to be torn all the way off, i.e. the appendage can remain partially intact while still expelling the liquid. This is advantageous because it prevents the appendage from unwantingly getting washed down the drain and clogging up the drain. In the alternative, the appendage can be completely torn off along the dotted tear line.

### EXAMPLE 2

### Jam

The dispensing device is used to apply jam on a piece of toast. The dispensing port is a flat back break tip. The person holds the dispensing device by placing her index finger and middle finger on the indent of the top/bottom portion of the deformable housing and the thumb of the same hand on the indent of the opposite portion of the deformable housing. Any fingers can be used to stabilize the dispensing device. The thumb holding the dispensing device can first apply pressure to the appendage in order to break open the dispensing port. After, the dispensing port has been broken open, the thumb, middle finger, and index finger apply pressure onto the indents of the top and bottom portions of the deformable housing thereby expelling the jam from the deformable housing onto a piece of toast. The person can then spread the jam on her toast and enjoy. The appendage can be completely torn off the dispensing device or remain partially intact.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A dispensing device comprising:
a deformable housing including a top portion and a bottom portion forming an internal volume;
a circumferential edge portion; and
a dispensing port wherein the dispensing port is elevated on the top portion of the deformable housing and the dispensing port is substantially flat along the circumferential edge portion.

2. A dispensing device according to claim 1, wherein the internal volume is a void.

3. A dispensing device according to claim 1, wherein the internal volume is an encasement.

4. A dispensing device according to claim 3, wherein the encasement contains at least one substance.

5. A dispensing device according to claim 4, wherein the at least one substance is a condiment, a personal care product, a medicament, a health product, a beauty product, a sports nutrition product, an industrial product, or an alcoholic beverage.

6. A dispensing device according to claim 1, wherein the circumferential edge portion is a ring, securing mechanism, border, or rim.

7. A dispensing device according to claim 6, wherein the circumferential edge portion separates the dispensing device into the top portion and bottom portion of the deformable housing.

8. A dispensing device according to claim 1, wherein the top portion and bottom portion of the deformable housing include an indent.

9. A dispensing device according to claim 8, wherein the indent on the top portion of the deformable housing is centered.

10. A dispensing device according to claim 8, wherein the indent on the bottom portion of the deformable housing is centered.

11. A dispensing device according to claim 8, wherein the indent is configured for finger placement.

12. A dispensing device according to claim 9, wherein the finger placement includes an index finger and ring finger on the top portion of the dispensing device and a thumb on the bottom portion of the dispensing device.

13. A dispensing device according to claim 1, wherein the dispensing port is a flat back break tip.

14. A dispensing device according to claim 4, wherein the at least one substance is dispensed from the dispensing device by applying pressure to the deformable housing.

15. A dispensing device according to claim 12, wherein pressure is applied to the deformable housing by placing the index finger and the middle finger on the top portion of the deformable housing and the thumb on the indent and pressing down.

16. A dispensing device according to claim 12, wherein pressing down on the deformable housing is configured to allow the bottom portion of the deformable housing to collapse into the top portion of the deformable housing thereby substantially expelling the at least one substance.

17. A dispensing device according to claim 1, wherein the dispensing device is formed from a compressible material.

18. A dispensing device according to claim 17, wherein the compressible material comprises at least one polymer.

19. A dispensing device according to claim 17, wherein the compressible material is aseptic.

20. A dispensing device according to claim 17, wherein the compressible material is free of Bisphenol A (BPA).

21. A dispensing device according to claim 1, wherein the dispensing device is substantially spherical.

22. A dispensing device according to claim 21, wherein the dispensing device comprises a substantially circular cross-section.

23. A dispensing device according to claim 1, wherein the internal volume is about 3.0 fluid ounces.

24. A dispensing device according to claim 1, wherein the internal volume is about 20 ml of fluid.

25. A dispensing device according to claim 1, wherein the internal volume is about 0.5 to about 1.0 fluid ounces, about 1.0 to about 2.0 fluid ounces, about 2.0 to about 3.0 fluid ounces, about 3.0 to about 4.0 fluid ounces, about 4.0 to about 5.0 fluid ounces, and about 5.0 to about 6.0 fluid ounces.

26. A dispensing device according to claim 1, wherein the internal volume is between about 5 mL and about 10 mL, between about 5 mL, about 15 mL, between about 10 mL to about 20 mL, between about 15 mL to about 25 mL, between about 20 mL to about 30 mL, between about 25 mL about 35 mL, or between about 30 mL to about 40 mL.

27. A dispensing device according to claim 5, wherein the at least one substance is a personal care product.

28. A dispensing device according to claim 27, wherein the personal care product is shampoo.

29. A dispending device according to claim 1, wherein the circumferential edge is substantially uniform around most of the dispensing device but then protrudes out into an appendage.

30. A dispensing device according to claim 29, where in the circumferential edge and the appendage are separated by a dotted tear line.

31. A dispensing device according to claim 29, wherein the appendage is a surface large enough for a thumb resting surface.

32. A method for dispensing comprising:
extruding at least one substance from a dispensing device by applying pressure from a first finger and a second finger on a top portion and a thumb on a bottom portion;
wherein the dispensing device includes a deformable housing including the top portion and the bottom portion forming an internal volume including the at least one substance;
a circumferential edge portion; and
a dispensing port wherein the dispensing port is elevated on the top portion of the deformable housing and the dispensing port is substantially flat along the circumferential edge portion.
